(19) United States
(12) Patent Application Publication
(10) Pub. No.: US 2026/0246561 A1
(43) Pub. Date: Aug. 20, 2026

(54) USER EQUIPMENT HOPPING FOR WIRELESS MESSAGE TRANSMISSION

(71) Applicant: Wichita State University, Wichita, KS (US)

(72) Inventors: Hyuck Kwon, Wichita, KS (US); Walter Roensch, JR., Wichita, KS (US); Shikhar Bhattarai, Wichita, KS (US)

(21) Appl. No.: 19/540,889

(22) Filed: Feb. 16, 2026

Related U.S. Application Data
(60) Provisional application No. 63/759,372, filed on Feb. 17, 2025.

(51) Int. Cl. H04L 1/00

(52) U.S. Cl. CPC H04L 1/0041

(57) ABSTRACT

A method of sending a message over a wireless network involves dynamically selecting user equipment devices based on signal-to-interference-plus-noise ratio (SINR) measurements. SINR measurement values are received from a plurality of pieces of user equipment. At least one of the plurality of pieces of user equipment is selected based on having a higher SINR measurement value than at least one other of the plurality of pieces of user equipment for high priority message routing. The message is transmitted over the network via the selected user equipment. The message may be encoded using a secret sharing network coding (SSNC) encoding algorithm into first and second encoded shares when at least three pieces of user equipment are available. Each encoded share is transmitted via the user equipment devices having the highest and next-highest SINR measurement values respectively.

### CROSS-REFERENCE TO RELATED APPLICATIONS

This application claims priority to U.S. Provisional Patent Application No. 63/759,372, titled USER EQUIPMENT HOPPING, filed Feb. 17, 2025, which is hereby incorporated by reference in its entirety.

### STATEMENT REGARDING FEDERALLY SPONSORED RESEARCH

This invention was made with government support under Grant No. 2326898 and 2515378 awarded by the National Science Foundation (NSF). The government has certain rights in the invention.

### FIELD OF INVENTION

The present disclosure relates to wireless data transmission for 5G and future generation wireless communication systems, and more particularly to a method for improving message delivery reliability by dynamically selecting user equipment devices based on signal-to-interference-plus-noise ratio measurements for routing high priority messages.

### BACKGROUND

This disclosure pertains to wireless data transmission for 5G and future wireless communication protocols.

When data is transferred wirelessly, the transmitted signal is exposed to unwanted third parties or harmful parties such as denial of service (DoS) attackers. Additionally, there is always some level of interference/noise in the medium of the environment conveying the signal, especially during military operations wherein hostile jamming or severe fading is present. While there are obvious remedies with respect to hardware (better antennas, more power, etc.), there are less obvious remedies with respect to the data transfer process itself. “Network coding” is a generic term for the process of encoding and decoding information in specific ways in order to reduce the prevalence of errors, which can be defined in terms of “signal to interference plus noise ratio” (SINR). High performance user equipment (UE) may mitigate SINR. However, network coding has not traditionally utilized a method to determine which UE devices are of the highest quality.

Secret Sharing Network Coding (SSNC) is a technique used in many modern communication systems. It works by dividing a message into shares, each independently encoded, sending the shares to a plurality of transmitters, allowing the transmitters to transmit the shares to an intermediate node which combines at least part of the shares into a new data packet and relays the new data packet to a recipient. The recipient is able to decode the new data packet using the original data packet information.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure provides a processor-executable method of sending a message over a wireless network that improves message delivery reliability by dynamically selecting user equipment devices based on signal-to-interference-plus-noise ratio (SINR) measurements. SINR measurement values are received by a source device from a plurality of pieces of user equipment. The source device selects at least one of the plurality of pieces of user equipment having a higher SINR measurement value than at least one other of the plurality of pieces of user equipment for high priority message routing and transmits the message over the network via the selected user equipment.

In accordance with certain methods in the scope of the present disclosure, a source device may encode a message using a secret sharing network coding (SSNC) encoding algorithm into first and second encoded shares when at least three pieces of user equipment are available and transmit each encoded share via the user equipment devices having the highest and next-highest SINR measurement values respectively, while optionally transmitting a low priority message via a third user equipment device having a lower SINR measurement value.

In one embodiment, a processor-executable method of sending a message over a wireless network is provided. In this embodiment, the method includes receiving SINR measurement values from a plurality of pieces of user equipment. The method further includes selecting, for high priority message routing, at least one of the plurality of pieces of user equipment for having a higher SINR measurement value than at least one other of the plurality of pieces of user equipment. The method further includes transmitting the message over the network via the selected at least one of the plurality of pieces of user equipment.

In other embodiments, the method may include one or more of the following features. The message may be a high priority message. The method may further include transmitting a low priority message over the network via one of said at least one other of the plurality of pieces of user equipment. The plurality of pieces of user equipment may include at least three pieces of user equipment. The selecting may include selecting a first one of the plurality of pieces of user equipment with a highest SINR measurement value among the plurality of pieces of user equipment and a second one of the plurality of pieces of user equipment with a next-highest SINR measurement value among the plurality of pieces of user equipment. The transmitting may include encoding the message using an SSNC encoding algorithm into first and second encoded shares and transmitting the first encoded share via the first one of the plurality of pieces of user equipment and transmitting the second encoded share via the second one of the plurality of pieces of user equipment. The message may be a high priority message. The method may further include transmitting a low priority message over the network via a third one of the plurality of pieces of user equipment. The method may further include adding one bit to a header of the message to indicate the message is a high priority message before transmitting the message via the selected at least one of the plurality of pieces of user equipment.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a proposed UE hopping system for wireless communication, according to aspects of the present disclosure.

FIG. 2 illustrates a block diagram of an existing secret sharing network coding system, according to the prior art.

FIG. 3 illustrates a block diagram of a proposed secret sharing network coding system with user equipment hopping, according to aspects of the present disclosure.

FIG. 4 illustrates a graph showing block error rate versus signal-to-noise ratio, according to aspects of the present disclosure.

FIG. 5 illustrates a graph showing outage probability versus the number of user equipments, according to aspects of the present disclosure.

FIG. 6 illustrates a graph showing block error rate versus signal-to-noise ratio for different secret share pairs, according to aspects of the present disclosure.

FIG. 7 illustrates a graph showing throughput versus signal-to-noise ratio for different secret share pairs, according to aspects of the present disclosure.

FIG. 8 illustrates a graph showing probability of secret sharing network coding failure versus signal-to-noise ratio, according to aspects of the present disclosure.

FIG. 9 illustrates a graph comparing throughput versus signal-to-noise ratio for proposed and conventional systems, according to aspects of the present disclosure.

FIG. 10 illustrates a bar graph comparing the number of user equipment phones used between proposed and conventional systems, according to aspects of the present disclosure.

FIG. 11 illustrates a bar graph comparing latency between proposed and conventional systems, according to aspects of the present disclosure.

FIG. 12 illustrates a system diagram for wireless data transmission using user equipment hopping, according to aspects of the present disclosure.

FIG. 13 illustrates a screenshot of a terminal displaying received signal-to-interference-plus-noise ratio measurement data, according to aspects of the present disclosure.

FIG. 14 illustrates a screenshot of a mobile phone user interface displaying a signal-to-interference-plus-noise ratio measurement application, according to aspects of the present disclosure.

FIG. 15 illustrates a screenshot of a terminal displaying data channel communications received from multiple user equipment devices, according to aspects of the present disclosure.

Reference numerals in the drawings correspond to like elements in the detailed description. Such reference numerals are used to facilitate an understanding of the disclosure and are not intended to be limiting.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

This disclosure provides methods for improving wireless communications by user equipment (UE) hopping. A message source (e.g., a computer, a mobile device, or any other suitable digital communication device) in communication with a plurality of UEs periodically receives SINR measurement values from the UEs. When the message source has a high priority message to send, it first analyzes the SINR reports from its connected UEs to determine which UE(s) has the highest measured SINR value(s). The message source selects the UE(s) with the highest measured SINR value(s) for routing high priority messages. Before the high priority message is transmitted via the selected UE(s), one bit is added to a packet header of the message to indicate that the message is a high priority message. This priority indication bit is positioned at a predetermined location within the packet header such that a receiver can decode the bit to recognize the high priority nature of the message and perform appropriate processing or routing at the destination.

In some instances, the message source sends a high priority message and a low priority message in parallel. In these instances, the message source analyzes the current measured SINR values from the connected UEs and selects the UE(s) with the highest measured SINR values for the high priority message and selects the UE(s) with lower measured SINR values for the low priority message. Before transmission, one bit is added to the packet header of the high priority message to indicate its high priority, and a different bit value is added to the packet header of the low priority message to indicate its low priority. For example, a bit value of “1” may indicate high priority and a bit value of “0” may indicate low priority, or vice versa. On the receiver side, the UE dehopping stage 106 decodes the priority indication bit from the packet header to determine whether the received message is a high priority message or a low priority message, enabling proper de-permutation and routing to the appropriate destination. In this way, the system and method of the present disclosure permutes between the two different priority messages and ensures that the message with the high priority is sent via the UE(s) with the highest SINR value.

The system and method of the present disclosure can also be used to improve secret sharing network coding (SSNC) message delivery. Whereas conventional SSNC message delivery requires three Tx UEs (of unknown SINR) and three Rx UEs, which substantially increases computational complexity and block error rate (BLER), the system and method of the present disclosure enable SSNC message delivery using only two UEs on the Tx and Rx side of the core network. The message source analyzes current measured SINR values from at least three UEs and selects the UEs with the two highest SINR values to send a high priority SSNC message. No other UE is used on the Tx side to transmit the high priority SSNC message. As described in the attachments, an SSNC encoding algorithm is used to encode the high priority message into first and second encoded shares. A first one of the two selected UEs is used to transmit the first encoded share and a second one of the two selected UEs is used to transmit the second encoded share. Again, a low priority message may be transmitted in parallel via another UE of lower SINR.

In one or more embodiments, a processor-executable method of sending a message over a wireless network described herein operates in the context of fifth generation (5G) or future generation (G) wireless communication systems. In such systems, user equipment (UE) phones periodically measure signal-to-interference-plus-noise ratio (SINR) and report the measured SINR values to connected gNodeB base stations. This periodic measurement and reporting is performed according to existing 3GPP specifications, including Sections 5.1.5, 5.1.6, and 5.1.17 of 3GPP Technical Specification TS 38.215. The SINR measurement values are obtained from channel quality indicator (CQI) reports that each UE phone is required to measure and report to its connected gNodeB at regular intervals. The reporting period can be a slot interval of 1 ms, multiple slot intervals of 5 ms, multiple frames of 10 ms or 20 ms, or even longer intervals based on specific channel conditions and system parameters determined by the base station.

The UE hopping method disclosed herein exploits this prior knowledge of SINR measurements that UE phones report to connected gNodeB base stations. Because each UE phone channel quality is already available through the existing 5G standard requirements, the method does not require additional complexity for obtaining SINR information. The method assumes a quasi-static channel or block fading channel where the average SINR does not change significantly during a given message block transmission. This assumption is reasonable because a typical wireless network can have a sufficient coherent channel interval during which channel conditions remain relatively stable. By leveraging the available SINR information, the method improves reliability of high priority message delivery by routing such messages through UE phones exhibiting higher SINR values, which are less likely to be jammed or experiencing deep fading conditions.

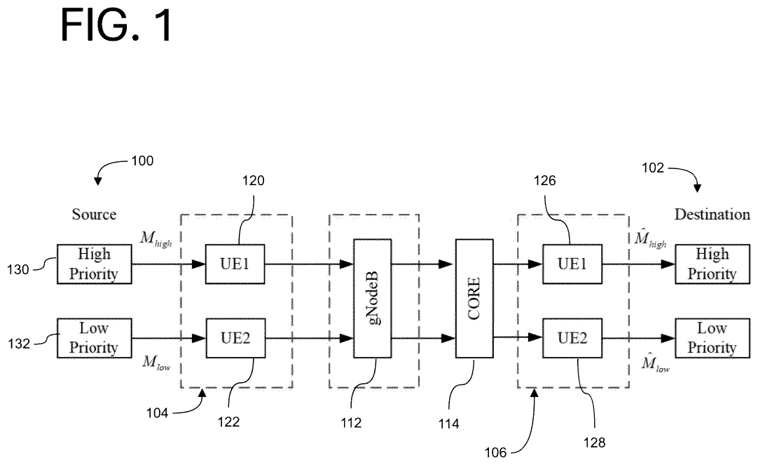

Referring to FIG. 1, one example embodiment of a proposed UE hopping system is shown. The proposed UE hopping system considers a communication system consisting of multiple UE phones and messages of various priorities that are transmitted from a source 100 to a destination 102. In the illustrated embodiment, the system includes a first transmitting user equipment 120 and a second transmitting user equipment 122, though the method can be extended to more than two UE phones with increasing improvement in outage probability as the number of UE phones increases. The proposed UE hopping system receives SINR measurement values from a plurality of pieces of user equipment, as described previously. The system selects, for high priority message routing, at least one of the plurality of pieces of user equipment for having a higher SINR measurement value than at least one other of the plurality of pieces of user equipment. In the illustrated embodiment, a high priority message 130 is transmitted via the UE phone having the higher SINR value, while a low priority message 132 is transmitted via the UE phone having the lower SINR value.

With continued reference to FIG. 1, the UE hopping stage 104 at the transmitter side permutes between the two different priority messages and ensures that the message with high priority is sent via the UE phone that has the higher value of SINR. Software based on the proposed algorithm is installed at the application layer of each UE phone. The corresponding SINR values are monitored by the software to ensure that the high priority message is sent via the UE phone having the highest SINR. The transmitter sends one bit of information at each packet protocol header to the destination 102 to indicate which phone delivers the high priority and low priority messages. De-permutation at the UE dehopping stage 106 on the receiver side is performed with the packet header information indicating the permutation done at the transmitter side.

The CQI reporting period can be a slot interval of 1 ms, multiple slot intervals of 5 ms, multiple frames of 10 ms or 20 ms, or longer intervals based on channel conditions and system configuration determined by the base station. Table 1 below shows an example of CQI (i.e., SINR) sequence for two UE phones for two report periods. Each column represents a CQI at two different UE phones for a given report period.

TABLE 1

| UE | CQI (Period 1) | CQI (Period 2) |
|---|---|---|
| UE1 | 1 | 9 |
| UE2 | 8 | 2 |

In the example shown in Table 1, the second transmitting user equipment 122 (UE2) has a higher CQI of 8 than the first transmitting user equipment 120 (UE1) with a lower CQI of 1 out of a scale of 10 in the first report period. In the second reporting period, UE1 has a higher CQI of 9 than UE2 with a lower CQI of 2. Accordingly, the high priority message is transmitted via UE2 and UE1 phones in the first and second reporting periods, respectively. The low priority message is delivered via UE1 and UE2 phones in the first and second reporting periods, respectively. The method transmits a low priority message over the network via one of the plurality of pieces of user equipment having a lower SINR measurement value while the high priority message is routed through the UE phone with the higher SINR measurement value.

The system can use a single gNodeB base station 112 to serve all UE phones through efficient beamforming directions, massive multiple-input multiple-output (MIMO) antenna assignments, independent resource blocks (RBs), and orthogonal frequency division multiplexing access (OFDMA) subcarrier assignments. An existing 5G single gNodeB or eNodeB can serve from 50 users at the theoretical minimum up to several hundred users depending on independent UEs simultaneously. The backbone network between gNodeBs is supported by optical fiber connections forming the core network 114. As further shown in FIG. 1, the first receiving user equipment 126 and the second receiving user equipment 128 receive the transmitted messages through the core network 114 and gNodeB base station 112 infrastructure.

The SINR-based UE hopping decision-making algorithm operates through a series of coordinated steps between EU devices and a connected computing device. In one embodiment, an Android phone is connected to a Windows PC through a USB cable. An application on the Android phone uses the telephony Android class to retrieve and periodically refresh received signal strength indicator (RSSI) and reference signal received quality (RSRQ) measurements. The SINR is estimated from the RSSI and RSRQ measurements using conversion tables specified in 3GPP Technical Specification TS 38.133 Table 10.1.16.1 and Section 5.1 of 3GPP Technical Specification TS 38.215.

The Android device and PC establish communications using the USB cable or a wireless link. The estimated SINR from the Android device is transmitted across the USB cable and recorded on the PC side at periodic intervals. An application on the PC side receives and processes the SINR data and coordinates sending messages to the phones based on the processed SINR information. The application uses the SINR values to route the highest priority message through the link exhibiting the highest SINR value among the available UE phones.

Software implementing the UE hopping algorithm is installed at the application layer of each UE phone. The software monitors SINR values and coordinates message routing between the UE phones and the connected PC or laptop. The software ensures that high priority messages are routed through UE phones exhibiting high SINR values while low priority messages are routed through UE phones exhibiting lower SINR values. This permutation of message routing based on link quality is performed at the transmitter side.

De-permutation at the receiver side is performed using packet header information that indicates the permutation performed at the transmitter side. As described previously, the method adds one bit to a header of the message to indicate the message is a high priority message before transmitting the message via the selected UE phone. In embodiments with more than two UE phones, the packet header includes log₂(N_{UE}) bits to indicate which UE phone delivers high priority messages and which UE phone delivers low priority messages, where N_{UE} represents the number of UE phones in the system. The receiver uses this header information to properly de-permute and decode the high priority and low priority messages from their respective UE phone transmissions.

Once messages are received at the destination side, the phones on the receiving side pass the messages to a connected PC, which processes the received messages according to the de-permutation information contained in the packet headers. The additional complexity due to the UE phone selection processing, including the permutation operation, is negligible because the packet header overhead consists of only log₂(N_{UE}) bits added to each packet.

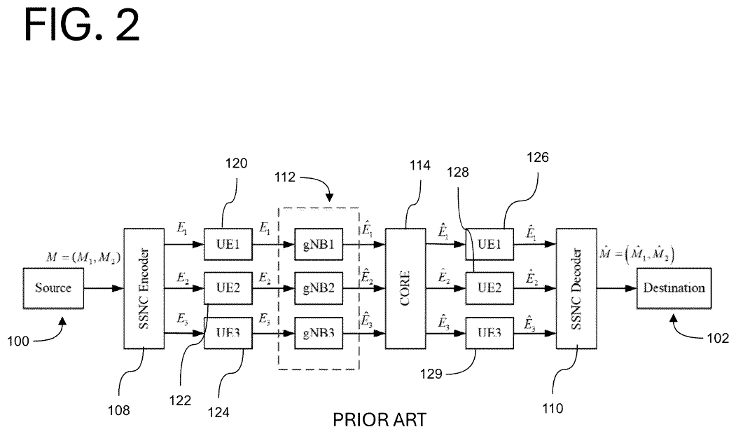

Referring to FIG. 2, one example embodiment of an existing secret sharing network coding (SSNC) system is shown. The existing SSNC system represents prior art that transmits a message M from a source 100 to a destination 102 using three separate transmission paths through first transmitting user equipment 120, second transmitting user equipment 122, and third transmitting user equipment 124. The SSNC encoder 108 receives the message M and generates three encoded shares that are transmitted through the three UE phones to corresponding gNodeB base stations 112 designated gNB1, gNB2, and gNB3. The encoded shares pass through the core network 114 to first receiving user equipment 126, second receiving user equipment 128, and third receiving user equipment 129. The SSNC decoder 110 reconstructs the estimated message from the received shares and delivers the reconstructed message to the destination 102.

The SSNC encoding algorithm splits the message M into two parts according to the equation:

$$M = ( {M}_{1} , {M}_{2} )$$

The SSNC encoder 108 generates two identical and independent (i.i.d.) binary bit sequences R₁ and R₂, each having a length of |M|/2, where |M| represents the total length of the message Min bits. The binary bit sequences R₁ and R₂ consist of random values from the set {0, 1}. The SSNC encoder 108 uses the message parts M₁ and M₂ together with the random bit sequences R₁ and R₂ to generate three SSNC encoded shares using XOR modular-two-summation operations denoted by the symbol ⊕.

The three SSNC encoded shares E₁, E₂, and E₃ are generated according to the following equations:

$${E}_{1} = ( {R}_{1} , {M}_{2} ⊕ {R}_{2} )$$

$${E}_{2} = ( {M}_{1} ⊕ {R}_{1} , {R}_{2} )$$

$${E}_{3} = ( {M}_{1} ⊕ {R}_{2} , {M}_{2} ⊕ {R}_{1} )$$

Each encoded share Eᵢ comprises two sub-blocks Eᵢ₁ and Eᵢ₂, where each sub-block has a length equal to |M|/2 bits. The first encoded share E₁ is transmitted via the first transmitting user equipment 120, the second encoded share E₂ is transmitted via the second transmitting user equipment 122, and the third encoded share E₃ is transmitted via the third transmitting user equipment 124.

The SSNC decoder 110 recovers the original message M from any two of the three encoded shares without requiring knowledge of the random bit sequences R₁ and R₂ that were used during encoding. From the share pair (E₁, E₂), the original message parts are recovered according to:

$${M}_{1} = {E}_{21} ⊕ {E}_{11}$$

$${M}_{2} = {E}_{12} ⊕ {E}_{22}$$

where Eᵢⱼ denotes the j-th sub-block of the transmitted block Eᵢ.

From the share pair (E₁, E₃), the original message parts are recovered according

$${M}_{1} = {E}_{31} ⊕ {E}_{12} ⊕ {E}_{32} ⊕ {E}_{11}$$

$${M}_{2} = {E}_{32} ⊕ {E}_{11}$$

From the share pair (E₂, E₃), the original message parts are recovered according to:

$${M}_{1} = {E}_{31} ⊕ {E}_{22}$$

$${M}_{2} = {E}_{32} ⊕ {E}_{21} ⊕ {E}_{31} ⊕ {E}_{22}$$

The random bit sequences R₁ and R₂ provide secrecy protection against eavesdropping attacks. The mutual information between any transmitted SSNC encoded block Eᵢ and the original message Mis zero, as expressed by the following equations:

$$I ( {E}_{1} ; M ) = 0$$

$$I ( {E}_{2} ; M ) = 0$$

$$I ( {E}_{3} ; M ) = 0$$

The zero mutual information between each encoded share and the original message indicates that the message M is protected against eavesdropping even when the encoded shares E₁, E₂, and E₃ are transmitted via unsecure wireless channels. An eavesdropper intercepting any single encoded share cannot extract information about the original message M because each encoded share is statistically independent of the message content when considered in isolation.

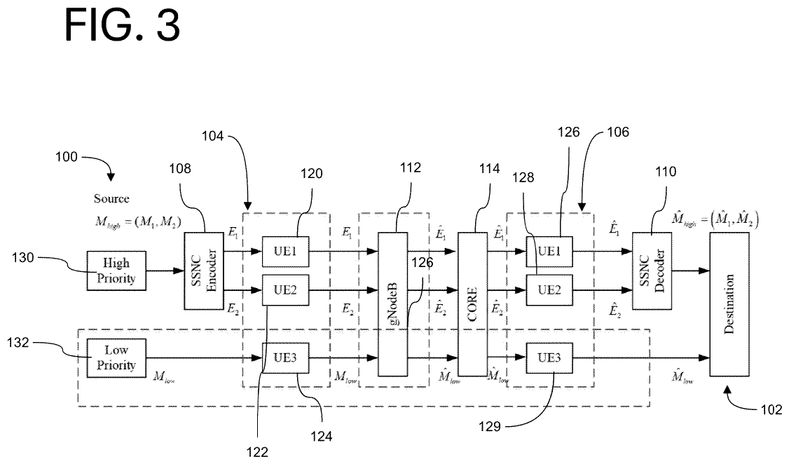

Referring to FIG. 3, one example embodiment of a proposed SSNC system with UE hopping in accordance with the present disclosure is shown. The proposed SSNC system with UE hopping receives SINR measurement values from a plurality of pieces of user equipment, where the plurality of pieces of user equipment comprises at least three pieces of user equipment. In the illustrated embodiment, the system includes a first transmitting user equipment 120, a second transmitting user equipment 122, and a third transmitting user equipment 124. The system selects, for high priority message routing, a first one of the plurality of pieces of user equipment with a highest SINR measurement value among the plurality of pieces of user equipment and a second one of the plurality of pieces of user equipment with a next-highest SINR measurement value among the plurality of pieces of user equipment. The third transmitting user equipment 124 having the lowest SINR measurement value among the three pieces of user equipment is excluded from high priority message transmission.

With continued reference to FIG. 3, the SSNC encoder 108 in the proposed SSNC system with UE hopping encodes a high priority message 130 designated M_{high} into only two encoded shares rather than three encoded shares. The high priority message 130 comprises message components M₁ and M₂ such that M_{high}=(M₁, M₂). The transmitting comprises encoding the message using an SSNC encoding algorithm into first and second encoded shares E₁ and E₂ according to the encoding equations described previously. The transmitting further comprises transmitting the first encoded share E₁ via the first one of the plurality of pieces of user equipment, which is the user equipment having the highest SINR measurement value. The transmitting further comprises transmitting the second encoded share E₂ via the second one of the plurality of pieces of user equipment, which is the transmitting user equipment having the next-highest SINR measurement value.

As further shown in FIG. 3, the message transmitted via the proposed SSNC system with UE hopping is a high priority message. The low priority message 132 designated M_{low} is transmitted over the network via a third one of the plurality of pieces of user equipment, which is the third transmitting user equipment 124 having the lowest SINR measurement value. The low priority message 132 is transmitted directly via the third transmitting user equipment 124 without SSNC encoding. In the illustrated example, the UE hopping stage 104 coordinates the routing of the first encoded share E₁ through the first transmitting user equipment 120, the second encoded share E₂ through the second transmitting user equipment 122, and the low priority message M_{low} through the third transmitting user equipment 124.

The proposed SSNC system with UE hopping achieves 33 percentile complexity reduction by using only two UE phone pairs instead of three UE phone pairs used in conventional SSNC. The conventional SSNC system shown in FIG. 2 uses three transmitting UE phones and three receiving UE phones, totaling six UE phones. The proposed SSNC system with UE hopping uses two transmitting UE phones for the high priority SSNC message and two receiving UE phones, totaling four UE phones for high priority message delivery. The third transmitting user equipment 124 and third receiving user equipment 129 handle only the low priority message without SSNC processing overhead.

The proposed SSNC system with UE hopping achieves 300 percentile latency shortening by processing only one share pair instead of all three share pairs during encoding and decoding. The conventional SSNC system processes all three secret share pairs (E₁, E₂), (E₁, E₃), and (E₂, E₃) for decoding the message. The proposed SSNC system with UE hopping processes only the single share pair (E₁, E₂) corresponding to the two UE phones with the highest SINR measurement values. The SSNC decoder 110 at the UE dehopping stage 106 decodes only the received share pair from the first receiving user equipment 126 and the second receiving user equipment 128 to reconstruct the estimated high priority message.

The proposed SSNC system with UE hopping does not require cooperation with connected gNodeB base stations 112, which is beneficial in war zones where gNodeBs are not trustworthy. The UE hopping algorithm operates at the application layer of the UE phones and exploits SINR measurement values that each UE phone reports to its connected gNodeB according to existing 5G standard requirements. The selection of UE phones based on SINR measurement values is performed locally without requiring the gNodeB to participate in the routing decision. The additional complexity due to UE phone selection processing is negligible because only log₂(N_{UE}) bits are added to each packet header to indicate the permutation performed at the transmitter side.

### BSC Analysis

To analyze the proposed system, it is useful to consider block error rate (BLER), failure probability, and throughput for SSNC evaluation under a wireless physical layer (PHY) channel environment instead of bit error rate (BER). This is because the receiver requests retransmission to the transmitter whenever a block error occurs, which causes latency. Every message bit for the proposed SSNC system with UE hopping as well as the existing SSNC system shown in FIG. 2 passes through a noisy PHY channel. The following analysis models the overall channel from a transmitter message bit before SSNC encoding to a receiver message bit after SSNC decoding as a binary symmetric channel (BSC) with crossover probability εᵢ, where i=1, . . . , N_{UE}. The BSC model includes the effects of modulation and forward error correction (FEC) encoding and decoding performed in user equipment and gNodeB base stations 112. The number of UE phones N_{UE} is set to 3 for this SSNC analysis.

For binary phase shift keying (BPSK) modulation, the SSNC encoded message bit stream Eᵢ is transmitted over a nonidentical BSC via the i-th transmitting user equipment with crossover probability εᵢ. The crossover probability can be written in terms of SINR and the Q-function tail probability under Gaussian noise jamming according to:

$${ε}_{i} = Q ( \sqrt{2 \cdot {SINR}_{i}} )$$

The Q-function is defined as:

$$Q ( α ) = {\int }_{a}^{∞} \frac{1}{\sqrt{2 π}} exp [ - \frac{1}{2} {t}^{2} ] dt$$

The SINR under Gaussian noise jamming can be written as:

$$SINR = \frac{S}{J + N} = \frac{S / N}{1 + J / N} = \frac{SNR}{1 + JNR}$$

where S, J, and N represent signal power, jamming power, and noise power, respectively. The SNR is defined as E_{b,i}/N₀, where E_{b,i} is the average energy per uncoded bit for the i-th user equipment and No is the one-sided additive white Gaussian noise (AWGN) power spectral density. The jamming-to-noise ratio (JNR) is assumed to be a given parameter. The BLER can be related to SINR for the jamming case and to SNR for the AWGN-only case without jamming.

### BLER Analysis

Let Êᵢⱼ denote the received j-th sub-block in the UEᵢ phone message block Êᵢ, where |Êᵢⱼ|=|Mᵢ|=|M|/2. The index i denotes the UEᵢ phone index and j denotes the SSNC message sub-block index, where i=1, 2, 3 and j=1, 2.

Let Nᵢⱼ denote the sub-block whose component is a BSC random variable with crossover probability equal to εᵢ. Let l denote the message bit index, where l=1, . . . , |M|. The received message bit can be written as:

$${\hat{E}}_{i j} ( l ) = {E}_{ij} ( l ) ⊕ {N}_{ij} ( l )$$

where Nᵢⱼ(l)=1 with probability εᵢ, and Nᵢⱼ(l)=0 with probability 1−εᵢ. If any message bit in a message block is incorrectly delivered, then a block error occurs.

The BLER after SSNC decoding with the secret share pair (E₁, E₂) can be expressed as:

$$BLER ( {E}_{1} , {E}_{2} ) = 1 - {[ {ε}_{1} {ε}_{2} + ( 1 - {ε}_{1} ) ( 1 - {ε}_{2} ) ]}^{\vert M \vert}$$

The BLER after SSNC decoding with the secret share pair (E₁, E₃) can be expressed as:

$$\begin{matrix}BLER ( {E}_{1} , {E}_{3} ) = 1 \\ - {[ {( 1 - {ε}_{3} )}^{2} {( 1 - {ε}_{1} )}^{2} + 4 {ε}_{1} {ε}_{3} ( 1 - {ε}_{1} ) ( 1 - {ε}_{3} ) + {{ε}_{1}^{2} ( 1 - {ε}_{3} )}^{2} + {{ε}_{3}^{2} ( 1 - {ε}_{1} )}^{2} + {ε}_{1}^{2} {ε}_{3}^{2} ]}^{\vert M \vert / 2} \\ \times {[ {ε}_{1} {ε}_{3} + ( 1 - {ε}_{1} ) ( 1 - {ε}_{3} ) ]}^{\vert M \vert / 2}\end{matrix}$$

The BLER after SSNC decoding with the secret share pair (E₂, E₃) can be expressed as:

$$\begin{matrix}BLER ( {E}_{2} , {E}_{3} ) = 1 \\ {- [ ( 1 - {ε}_{3} ) ( 1 - {ε}_{2} ) + {ε}_{3} {ε}_{2} ) ]}^{\vert M \vert / 2} \\ \times {[ {( 1 - {ε}_{3} )}^{2} {( 1 - {ε}_{2} )}^{2} + 4 ( 1 - {ε}_{3} ) ( 1 - {ε}_{2} ) {ε}_{3} {ε}_{2} + {( 1 - {ε}_{3} )}^{2} {ε}_{2}^{2} + {{ε}_{3}^{2} ( 1 - {ε}_{2} )}^{2} + {ε}_{3}^{2} {ε}_{2}^{2} ]}^{\vert M \vert / 2}\end{matrix}$$

The BLER can also be expressed as the ratio of the number of negative acknowledgments (NACKs) to the total number of transmitted blocks:

$$B L E R = \frac{\# NACKs}{\# ACKs + \# NACKs}$$

Throughput is a metric that measures the actual data bits successfully received over a certain period of time. Throughput is defined as:

$$\begin{matrix}Throughput = \frac{\# ACKs \cdot \# Bits per Block}{( \# ACKs + \# NACKs ) Block Time Interval} \\ = ( 1 - BLER ) \cdot \frac{\# Bits per Block}{Block Time Interval}\end{matrix}$$

### Probability of Proposed UE Hopping-Assisted SSNC Failure

The proposed UE hopping-assisted SSNC uses only the pair of best two UE phones, for example share pair (E₁, E₂), using the available prior information on SINR. Whenever a block error occurs in the best share pair, the packet is not delivered and is treated as an SSNC failure. Therefore, the probability of the proposed UE hopping-assisted SSNC failure can be expressed as:

$$Pr ( Proposed UE Hopping Assisted SSNC Failure ) = min \{ BLER ( {E}_{1} , {E}_{2} ) , BLER ( {E}_{1} , {E}_{3} ) , BLER ( {E}_{2} , {E}_{3} ) \}$$

The BLER (E₁, E₂), BLER (E₁, E₃), and BLER (E₂, E₃) values are computed using the BLER equations defined previously. The probability of the proposed SSNC failure with UE hopping can be used as the BLER in the throughput expression for performance evaluation.

### Probability of Conventional SSNC Failure

For the conventional SSNC system shown in FIG. 2, an SSNC failure occurs if two or more share pairs fail. The probability of conventional SSNC failure can be expressed as:

$$\begin{matrix}Pr [ Conventional SSNC Failure ] = BLER ( {E}_{1} , {E}_{2} ) \cdot BLER ( {E}_{1} , {E}_{3} ) + BLER ( {E}_{1} , {E}_{2} ) \cdot BLER ( {E}_{2} , {E}_{3} ) \\ + BLER ( {E}_{1} , {E}_{3} ) \cdot BLER ( {E}_{2} , {E}_{3} ) - 2 \cdot BLER ( {E}_{1} , {E}_{2} ) \cdot BLER ( {E}_{1} , {E}_{3} ) \cdot BLER ( {E}_{2} , {E}_{3} )\end{matrix}$$

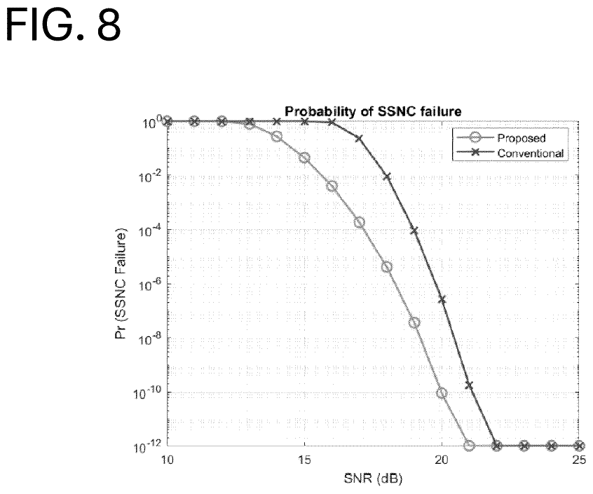

The BLER (E₁, E₂), BLER (E₁, E₃), and BLER (E₂, E₃) values are computed using the BLER equations defined previously. The probability of conventional SSNC failure can be used as the BLER in the throughput expression for comparison with the proposed system. As shown in FIG. 8, the proposed UE hopping-assisted SSNC achieves significantly lower failure probability than the conventional SSNC at a given SNR.

### Numerical Results

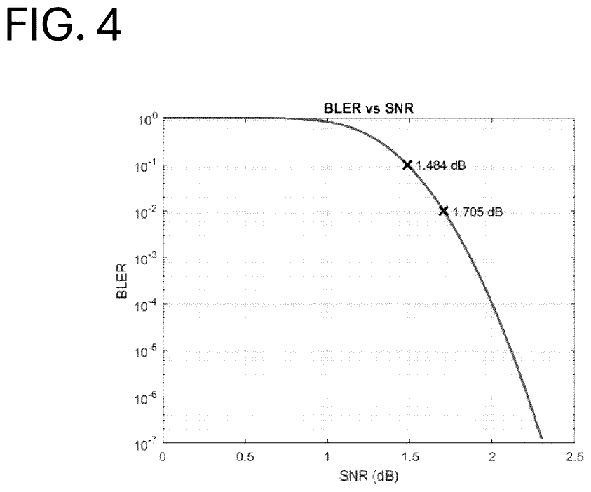

Referring to FIG. 4, the theoretical relationship between block error rate (BLER) and signal-to-noise ratio (SNR) is shown. The channel dispersion V is computed using the channel capacity and its derivative with respect to SNR. Using the channel dispersion V, the BLER is obtained from finite blocklength analysis. The maximum code block size is K_{cb}=8,448 when a low density parity check (LDPC) base graph 1 is used. For the numerical results shown in FIG. 4, a message block length |M|=4,096 is chosen, which corresponds to a polar code configuration suitable for future generation wireless links. A code rate R_{c}=⅓ is used, and the SNR range spans from 0 to 2.3 dB. As shown in FIG. 4, to attain a BLER of 10⁻¹, the SNR must be maintained at 1.484 dB, whereas to achieve a BLER of 10⁻², a higher SNR of 1.705 dB must be maintained. These two operating points are indicated by cross marks on the curve. To attain an even lower BLER of 10⁻⁴, a higher SNR of approximately 2 dB is needed. This relationship demonstrates that the lower the BLER required, the higher the SINR must be maintained, which is fundamental to understanding how the proposed UE hopping method improves message delivery reliability by selecting transmission paths with higher SINR values.

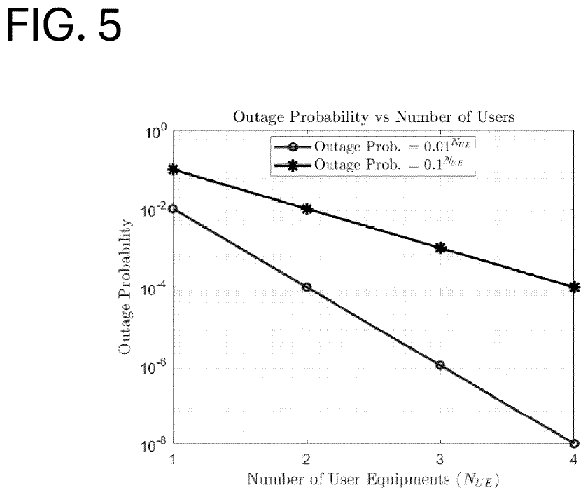

Referring to FIG. 5, the outage probability versus number of user equipments is shown under log-normal fading conditions. The parameters used for the numerical results are as follows: log-normal shadowing standard deviation σ_{ψdB}=3.65 dB; free space path loss constant K=−31.54 dB; transmit power=10 mW; and minimum required received power=−110.5 dBm at a distance of 150 meters. For these parameters, two scenarios are considered. In the first scenario, the outage probability for a single-user case is computed to be 0.01. In the second scenario, the outage probability for a single-user case is 0.1. In both scenarios, as the number of UE phones N_{UE} increases, the outage probability equals the single-UE outage probability raised to the power of N_{UE}. The outage probabilities are shown for both cases with the number of UE phones N_{UE} varying from 1 to 4. For N_{UE}=2, the first scenario shows an improvement in outage probability over the single UE case by two decades, while the second scenario shows an improvement by one decade. For N_{UE}=4, the first scenario shows an improvement in outage probability over the single UE case by six decades, while the second scenario shows an improvement by three decades. Therefore, as N_{UE} increases, the proposed UE hopping method can improve the outage probability significantly compared to the case of no UE hopping where N_{UE}=1.

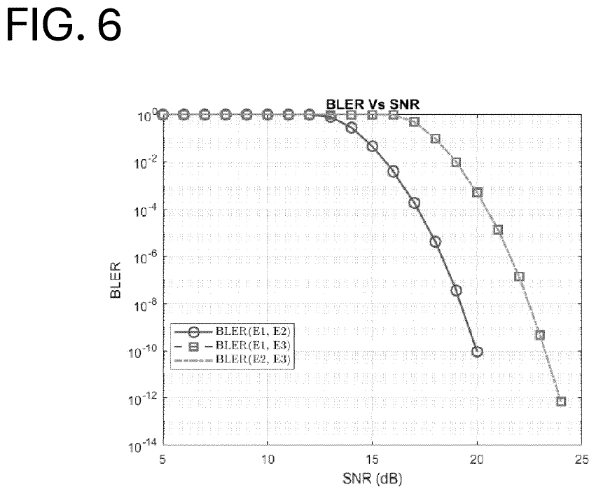

Referring to FIG. 6, the BLER for each secret share pair is shown versus SNR for a realistic scenario in which the UE phone channels are not identical. Different jamming powers are assigned to each encoded message link, with JNR=0, 4, and 8 dB assigned to the E₁, E₂, and E₃ links, respectively. Since the jamming power is lowest for the share pair (E₁, E₂), this pair has the lowest BLER for SNR values above 13 dB. At 15 dB SNR, the BLER for share pair (E₁, E₂) is 0.044, while the BLER for the other two share pairs is 1. The proposed system takes advantage of the known SINR and selects the share pair having the best SINR, which results in the lowest BLER.

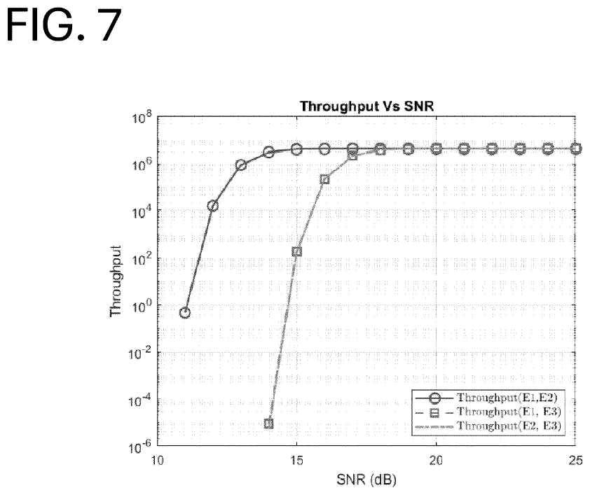

Referring to FIG. 7, the throughput for each secret share pair is shown versus SNR. For a block time interval of 1 ms corresponding to a slot interval and |M|=4,096 message bits per block, the throughput results demonstrate that even at low SNRs below 15 dB, the share pair (E₁, E₂) has the highest throughput compared to the other two pairs. At 16 dB SNR, the share pair (E₁, E₂) has throughput of 4,079,910 whereas the other two pairs have only 209,746. This is because the share pair (E₁, E₂) has the lowest combined jamming power of JNR=(0, 4) dB, while the other two pairs have JNR=(0, 8) dB and JNR=(4, 8) dB respectively.

Referring to FIG. 8, the probability of SSNC failure is shown for both the proposed system and the conventional system. At an SNR of 20 dB, the proposed system has an SSNC failure probability of 9.14×10⁻¹¹, while the conventional system has a higher failure probability of 2.68×10⁻⁷. This represents more than three orders of magnitude improvement in SSNC failure probability for the proposed system at a given SNR.

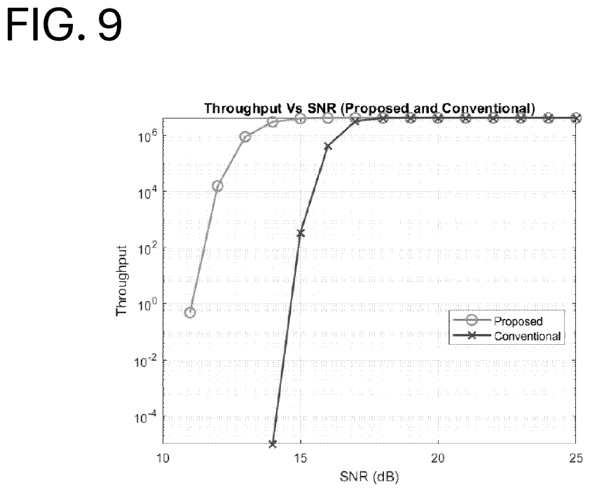

Referring to FIG. 9, the throughput comparison between the proposed system and the conventional system is shown. At 15 dB SNR, the proposed system has throughput of 3,915,500 while the conventional system has only 332. This represents an improvement factor of approximately 11,793 times. After SNR exceeds 17 dB, both the proposed and conventional systems perform almost the same in terms of throughput.

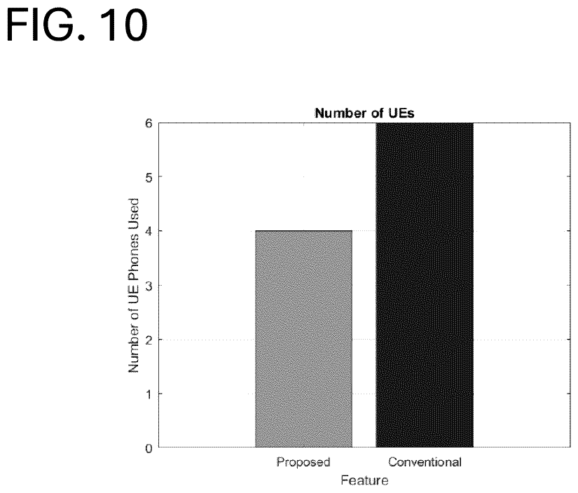

Referring to FIG. 10, the total number of transmitting and receiving UE phones used by each system is compared. The conventional SSNC system uses six UE phones total, comprising three transmitting UE phones and three receiving UE phones. The proposed system uses only four UE phones total, comprising two transmitting UE phones and two receiving UE phones. This represents a 33 percentile complexity reduction.

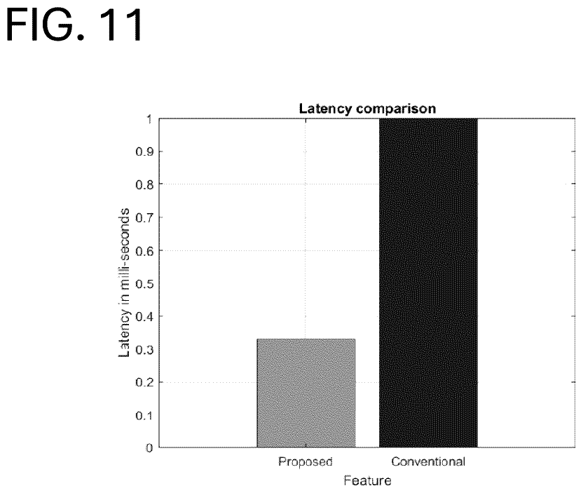

Referring to FIG. 11, the latency comparison between the proposed system and the conventional system is shown. The proposed system achieves 300 percentile improvement in latency compared to the conventional system. This improvement occurs because the conventional SSNC system uses all three share pairs for decoding the message, namely (E₁, E₂), (E₁, E₃), and (E₂, E₃), while the proposed system uses only a single best pair. If the additional latency caused by frequent NACK transmissions from the receiver or block errors is included, the conventional scheme will have much longer overall latency than the proposed system.

### Example Demonstration

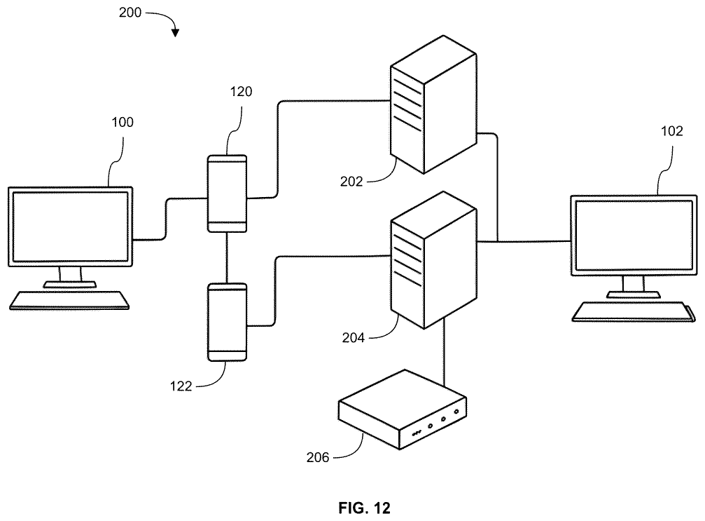

Referring to FIG. 12, a system 200 is shown that demonstrates one network configuration for the proposed UE hopping method. The system 200 uses a WebRTC (Web real-time communication) P2P (peer-to-peer) communication scheme. Two user equipment devices, first transmitting user equipment 120 and second transmitting user equipment 122, are connected to source 100 (e.g., a personal computer) via USB. The user equipment devices use first signaling server 202 and second signaling server 204 to establish a WebRTC connection with destination 102 (e.g., a personal computer), which is connected to both signaling servers. A STUN server 206 is used to establish the P2P connection between the user equipment devices and the destination 102.

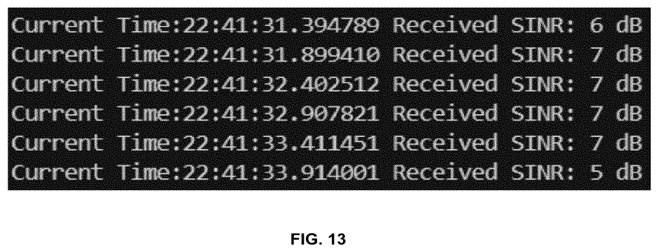

Referring to FIG. 13, SINR data transmitted from a UE phone 120, 122 to a connected source 100 is shown. In this example, the UE phone was initially placed on one side of a table facing east with a measured SINR of 6 dB. Moments later, the UE phone was moved to the other end of the table, changing the SINR from 6 dB to 7 dB. Finally, the UE phone was turned to face west, changing the SINR from 7 dB to 5 dB. This simple example demonstrates how volatile the SINR can be spatially and, by extension, how significant the effect on UE hopping assisted priority message delivery can be when routing is based on SINR link quality.

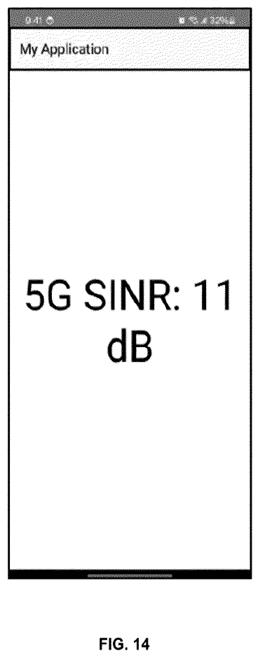

Referring to FIG. 14, an Android application displaying the current 5G SINR is shown. The application retrieves and displays the SINR measurement using the Android telephony class. The application also performs USB communication with a laptop and transmits messages across a 5G network. The SINR value enables the system to determine which user equipment device has the highest signal quality for routing high-priority messages.

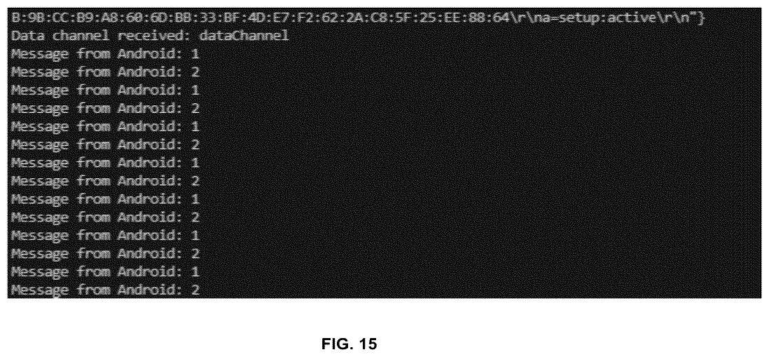

Referring to FIG. 15, the terminal of a receiving personal computer 102 is shown displaying messages received via the P2P connection. One phone continuously transmits the number 1 and the other phone continuously transmits the number 2. This demonstrates that the proof of concept can accomplish all required criteria to properly function, including establishing USB-based communication between multiple Android devices and a personal computer, receiving messages from both phones concurrently, and distinguishing between data streams from different user equipment devices.

A number of implementations have been described. Nevertheless, it will be understood that various modifications may be made without departing from the spirit and scope of the disclosure. Accordingly, other implementations are within the scope of the following claims.

A number of implementations have been described. Nevertheless, it will be understood that various modifications may be made without departing from the spirit and scope of the disclosure. Accordingly, other implementations are within the scope of the following claims.

1. A processor-executable method of sending a message over a wireless network, the method comprising:
receiving SINR measurement values from a plurality of pieces of user equipment;
selecting, for high priority message routing, at least one of the plurality of pieces of user equipment for having a higher SINR measurement value than at least one other of the plurality of pieces of user equipment; and
transmitting the message over the network via the selected at least one of the plurality of pieces of user equipment.

2. The method of claim 1, wherein the message is a high priority message.

3. The method of claim 2, further comprising transmitting a low priority message over the network via one of said at least one other of the plurality of pieces of user equipment.

4. The method of claim 1, wherein the plurality of pieces of user equipment comprises at least three pieces of user equipment.

5. The method of claim 4, wherein said selecting comprises selecting a first one of the plurality of pieces of user equipment with a highest SINR measurement value among the plurality of pieces of user equipment and a second one of the plurality of pieces of user equipment with a next-highest SINR measurement value among the plurality of pieces of user equipment.

6. The method of claim 5, wherein said transmitting comprises encoding the message using an SSNC encoding algorithm into first and second encoded shares and transmitting the first encoded share via the first one of the plurality of pieces of user equipment and transmitting the second encoded share via the second one of the plurality of pieces of user equipment.

7. The method of claim 6, wherein the message is a high priority message.

8. The method of claim 7, further comprising transmitting a low priority message over the network via a third one of the plurality of pieces of user equipment.

9. The method of claim 1, further comprising adding one bit to a header of the message to indicate the message is a high priority message before transmitting the message via the selected at least one of the plurality of pieces of user equipment.
